(19) United States
(12) Patent Application Publication
(10) Pub. No.: US 2017/0301918 A1
(43) Pub. Date: Oct. 19, 2017

(54) ELECTRODE MATERIAL OF FORMULA LiFe1-xCoxBO3 AND PRODUCTION METHOD THEREOF

(71) Applicant: COMMISSARIAT A L'ENERGIE ATOMIQUE ET AUX ENERGIES ALTERNATIVES, Paris (FR)

(72) Inventors: Barbara LE ROUX, Grenoble (FR); Carole BOURBON, Saint Michel De Saint Geoirs (FR); Jean-François COLIN, Meylan (FR)

(73) Assignee: COMMISSARIAT A L'ENERGIE ATOMIQUE ET AUX ENERGIES ALTERNATIVES, Paris (FR)

(21) Appl. No.: 15/510,536

(22) PCT Filed: Aug. 24, 2015
(86) PCT No.: PCT/FR2015/052253

§ 371 Date: Mar. 10, 2017

(30) Foreign Application Priority Data
Oct. 17, 2014 (FR) 1460004

(51) Int. Cl. H01M 4/58; C01B 35/12; H01M 10/0525; H01M 4/02

(52) U.S. Cl. CPC H01M 4/5825; H01M 10/0525; C01B 35/128; C01P 2002/72; H01M 2004/028

(57) ABSTRACT

The present invention relates to an electrode material of formula LiFe₁₋ₓCoₓBO₃, where 0<x<1, and to a method of preparing the same comprising independently preparing an iron borate and a cobalt borate and then simultaneously thermally treating them under an inert atmosphere, in the presence of a precursor of lithium and of boric acid.

### DOMAIN OF THE INVENTION

The invention relates to a material made from lithium-borate having formula LiFe₁₋ₓCoₓBO₃, as well as to the use thereof as an electrode material and to its preparation method.

The field of use of the present invention particularly relates to energy storage, and more particularly to lithium-ion batteries.

### BACKGROUND

During the last decades, different types of batteries have been developed to respond to the size, weight, and capacity requirements depending on the nature of the electronic devices. For example, lithium-ion batteries are particularly well adapted to portable electronic equipment in terms of energy density and of time stability (charge/discharge cycles).

Generally, a lithium-ion battery is an assembly of a positive electrode (cathode), comprising a material made from lithium, and of a negative electrode (anode) generally made from carbon (graphite, for example). Its operation is ensured by the reversible exchange of Li⁺ ions between the cathode and the anode, the electrodes being separated by an electrolyte made from lithium salt.

In the development of lithium-ion batteries, many positive electrode materials have been tested, and particularly LiMPO₄ phosphates (M=Mn, Fe, or Co). Such materials are advantageous and arouse much interest due to the security that they provide and to their low cost. However, their theoretical specific capacity remains limited to 170 mAh/g for LiFePO₄.

To obtain batteries having higher specific capacities, other materials have been envisaged, particularly LiMBO₃ borates (M=Mn, Fe, or Co). These materials have the advantage of having a maximum theoretical capacity (220 mAh/g) greater than that of LiMPO₄ phosphates, while being as attractive in terms of security.

However, the redox potentials of couples Fe²⁺/Fe³⁺ and Mn²⁺/Mn³⁺ are relatively low, which results in limiting the energy density of the LiFeBO₃ and LiMnBO₃ compounds.

The LiCoBO₃ compound enables to improve the energy density, given that the Co²⁺/Co³⁺ redox couple of cobalt has a higher potential than couples Fe²⁺/Fe³⁺ and Mn²⁺/Mn³⁺. However, the disadvantage of the LiCoBO₃ compound with respect to LiFeBO₃ and LiMnBO₃ compounds is its rather low experimental reversible capacity.

There thus is a need to improve the properties of lithium-borate materials, by developing a material having the following properties:
a satisfactory energy density;
a good specific mass capacity; and
a good stability over time regarding charge/discharge cycles.

The present invention relates to lithium-borate compounds, having properties enabling to solve this problem. They comprise at the same time the two transition metals, iron and cobalt.

Further, the Applicant has observed that prior art methods do not enable to prepare such compounds comprising, at the same time, lithium iron and cobalt borates. Such methods do not result in the forming of a single phase containing the iron and the cobalt.

To overcome this technical issue, the Applicant has developed a novel method, in a plurality of steps, which takes into account possible incompatibilities relative to the respective reactivities of the cobalt and iron compounds.

### SUMMARY OF THE SPECIFICATION

The present invention aims at a lithium-borate material containing both iron and cobalt. The partial substitution of iron with cobalt in the LiFeBO₃ material enables to improve the energy density by increase of the average reaction potential.

This material may be used in various fields of application, particularly in the field of energy storage. It appears to be particularly attractive to form the electronically-active material of the cathode of a lithium-ion battery.

More specifically, the present invention relates to an electrode material of formula LiFe₁₋ₓCoₓBO₃, where 0<x<1.

Advantageously, x is greater than 0 and smaller than or equal to 0.3 (0<x≦0.3), and, more advantageously still, x=0.3.

This material appears in crystal form and crystallizes in a monoclinic cell. It has a theoretical specific mass capacity in the range from 215 to 220 mAh/g, which makes it particularly adapted for a use as an active electrode material, advantageously for the cathode of a lithium-ion battery.

Another object of the invention relates to the method of solid-state preparation of such an electrode material of formula LiFe₁₋ₓCoₓBO₃, with 0<x<1. The method comprises the steps of:
a) preparing an iron borate from an iron compound and a boron compound by:
   a1) milling of a mixture of an iron compound and of a boron compound;
   a2) thermal treatment of the mixture thus obtained, under an inert atmosphere, advantageously under argon, at a temperature in the range from 300 to 1,000° C., advantageously from 550 to 850° C.;
b) preparing a cobalt borate from a cobalt compound and a boron compound by:
   b1) milling of a mixture of a cobalt compound and of a boron compound;
   b2) thermal treatment of the mixture thus obtained, under an oxidizing atmosphere, advantageously air, at a temperature in the range from 300 to 1,000° C., advantageously from 550 to 850° C.;
c) preparing a mixture containing the iron borate, the cobalt borate, a precursor of lithium, and boric acid;
d) thermally treating the mixture under an inert atmosphere, advantageously under argon;
e) obtaining a material of formula LiFe₁₋ₓCoₓBO₃, with 0<x<1.

This method requires separately synthesizing the iron and cobalt borates. The conditions adapted to each of these borates thus ease the stabilizing of the cobalt in the 2+ oxidation state during the forming of the mixed LiFe₁₋ₓCoₓBO₃ compound.

However, the mixed LiFe₁₋ₓCoₓBO₃ compound is not obtained when the iron, cobalt, and boron compounds are treated simultaneously in a single step. In this case, the cobalt 2+ can be easily reduced into metal cobalt during a thermal treatment under an inert atmosphere, while the iron 2+ can be easily oxidized into iron 3+ during a thermal treatment in air.

Generally, the iron compound used at step a1) is advantageously selected from the group comprising iron oxalate (FeC₂O₄, which may in particular be in hydrated or non-hydrated form); iron carbonate (FeCO₃); and iron oxide (II) (FeO). A mixture of these compounds may also be used.

Generally, the cobalt compound used at step b1) is advantageously selected from the group comprising: cobalt oxalate (CoC₂O₄, which may in particular be in hydrated or non-hydrated form); cobalt carbonate (hydrated or non-hydrated CoCO₃); and cobalt oxide (II) (CoO). A mixture of these compounds may also be used.

The boron compound used at steps a1) and b1) is advantageously boron oxide (B₂O₃) or boric acid (H₃BO₃). A mixture of these compounds may also be used.

The boron compound used at step a1) may be different from that used at step b1).

At step a1), the molar ratio between the iron compound and the boron compound is generally in the range from 0.6 to 1.2, more advantageously from 0.8 to 1.

At step b1), the molar ratio between the cobalt compound and the boron compound is generally in the range from 0.6 to 1.2, more advantageously from 0.8 to 1.

Molar ratio means the molar ratio of the molar quantity of iron, or of cobalt, to the molar quantity of boron.

The milling implemented at steps a1) and b1) may be performed by any adapted means known by those skilled in the art. It enables to reduce the solid iron, cobalt, and boron compounds into a fine powder.

The milling enables not only to obtain a fine homogeneous powder, but also to increase the specific surface area of these compounds and thus to improve their reactivity.

Advantageously, the milling of steps a1) and/or b1) may be carried out in a conventional ball mill.

According to a specific embodiment, when the mill is a ball mill, the rotation speed of the mill is advantageously in the range from 100 to 900 revolutions/minute, more advantageously from 250 to 750 revolutions/minute. It may also be equal to 500 revolutions/minute.

Advantageously, the duration of the milling of steps a1) and/or b1) is in the range from 0.5 to 24 hours, more advantageously from 1 to 12 hours. It may in particular be equal to 5 hours.

Preferably, the milled product resulting from step a1) or b1) appears in the form of a powder having an average grain diameter advantageously in the range from 0.1 to 30 micrometers, and more advantageously from 0.5 to 10 micrometers.

The milling conditions of steps a1) and b1) are independent from one another. In other words, the milling conditions for iron are not necessarily the same as for cobalt. Further, the average grain diameter of the mixture resulting from step a1) (iron) is not necessarily the same as that of the mixture resulting from step b1) (cobalt).

The thermal treatment (calcination) of the step a2) or b2), which follows mixing and milling step a1) or b1), enables the iron or cobalt compound to react with the boron compound to produce an iron borate or a cobalt borate.

As previously indicated, the thermal treatment of steps a2) and b2) is carried out under a different atmosphere for each material:
a2) under an inert atmosphere (advantageously, argon) to avoid the oxidation of the iron 2+ into iron 3+; and
b2) in air to avoid the reduction of the cobalt 2+, which quite easily occurs at temperatures higher than or equal to 500° C. under an inert atmosphere.

For these reasons, the iron and cobalt borates are prepared separately, prior to the synthesis of the LiFe₁₋ₓCoₓBO₃ compound by subsequent thermal treatment under an inert atmosphere at step d) and this, without reducing the cobalt 2+ into metal cobalt.

Advantageously, the thermal treatment (a2 and/or b2) may be a step of thermal quenching, that is, a treatment which comprise no progressive temperature rise.

According to another embodiment, the temperature of the thermal treatment (a2 and/or b2) is reached by applying a heating speed, advantageously in the range from 1 to 20° C./minute, more advantageously from 2 to 10° C./minute.

Preferably, the thermal treatment according to step a2) comprises heating the mixture resulting from step a1) up to a temperature advantageously in the range from 300 to 1,000° C., more advantageously from 550 to 850° C. It may also be in the range from 650 to 850° C., particularly when the thermal treatment is a thermal quenching step.

Preferably, the thermal treatment according to step b2) comprises heating the mixture resulting from step b1) up to a temperature advantageously in the range from 300 to 1,000° C., more advantageously from 550 to 850° C. It may also be in the range from 700 to 850° C., particularly when the thermal treatment is a thermal quenching step.

The duration of the thermal treatment (a2 and/or b2) is advantageously in the range from 5 to 1,200 minutes, more advantageously from 5 to 30 minutes. This duration may be in the range from 5 to 20 minutes, particularly when the thermal treatment is a thermal quenching step.

At the end of step a2) or b2), the iron or cobalt borate is cooled. The cooling speed is advantageously in the range from 2 to 20° C./minute, more advantageously from 5 to 10° C./minute, until the room temperature is reached.

Advantageously, the cooling is an air quenching step, that is, a treatment comprising no progressive temperature decrease. It is thus instantaneously passed from the thermal treatment temperature to the room temperature. For iron borate, it is an air quenching of the vessel (tube, for example) containing the sample (the closed vessel containing the sample is taken out in air but remains under an inert atmosphere).

The duration of the thermal treatment (a2 and/or b2) does not include the heating or cooling time.

The conditions of the thermal treatment of steps a2) and b2) are independent. In other words, the heating speed, the duration, and the temperature of the thermal treatment, and the cooling speed relative to iron borate are not necessarily the same as those relative to cobalt borate.

Further, the thermal treatment conditions, relative to the inert or oxidizing atmosphere, are adapted to the reactivity of the iron and cobalt compounds. Such a condition difference at steps a2) and b2) enables to subsequently obtain the monoclinic crystal compound of formula LiFe₁₋ₓCoₓBO₃ (with 0<x<1).

Once steps a) and b) have been carried out, the iron borate and the cobalt borate are mixed (and advantageously milled) in the presence of a precursor of lithium and of boric acid (step c)).

It will be within the abilities of those skilled in the art to adjust the respective quantities of these compounds to obtain the material of formula LiFe₁₋ₓCoₓBO₃ (with 0<x<1).

According to a specific embodiment, the mixture of step c) may comprise, for one mole of lithium:
from 0.01 to 0.5 moles of iron borate, advantageously from 0.03 to 0.35 moles;
from 0.01 to 0.5 moles of cobalt borate, advantageously from 0.03 to 0.35 moles;
from 0.001 to 0.5 moles of boric acid, advantageously from 0.01 to 0.35 moles.

The lithium precursor used at step c) is advantageously lithium carbonate (Li₂CO₃) or lithium hydroxide. Lithium hydroxide may appear in its hydrated or non-hydrated form (LiOH or LiOH.xH₂O). It may also be a mixture of these compounds.

According to a specific embodiment, step c) may be followed by a milling step, prior to the thermal treatment of step d). This optional milling is advantageously performed in a ball mill. In this case, the mill rotation speed is advantageously in the range from 100 to 900 revolutions/minute, more advantageously from 250 to 750 revolutions/minute.

The duration of the optional milling preceding step d) is advantageously in the range from 0.5 to 24 hours, more advantageously from 1 to 12 hours.

The optional milling preceding step d) enables to obtain a homogeneous powder having an average diameter advantageously in the range from 0.1 to 30 micrometers, more advantageously from 0.5 to 10 micrometers.

The mixture resulting from step c) (possibly milled) is then thermally treated at step d).

The temperature of the thermal treatment of step d) is advantageously in the range from 300 to 900° C., more advantageously from 400 to 700° C., and more advantageously still from 400 to 600° C.

The heating speed is advantageously in the range from 1 to 20° C./minute, more advantageously from 2 to 10° C./minute.

As already indicated, the thermal treatment of step d) is performed under an inert atmosphere, for example, under argon, or under nitrogen. Preferably, it is performed under argon.

The duration of the thermal treatment of step d) is advantageously in the range from 15 to 1,200 minutes, more advantageously from 30 to 1,200 minutes, and more advantageously still from 45 to 180 minutes. It may in particular be equal to 120 minutes. It is advantageously greater than or equal to 75 or 90 minutes, particularly at 500° C.

Advantageously, the thermal treatment may be a step of thermal quenching, that is, a treatment which comprises no progressive temperature rise.

At the end of step d), the material is cooled. The cooling speed is advantageously in the range from 2 to 20° C./minute, more advantageously from 5 to 10° C./minute, until the room temperature is reached.

Advantageously, the cooling is an air quenching step, that is, a treatment comprising no progressive temperature decrease. It is thus instantaneously passed from the thermal treatment temperature to the room temperature.

The duration of the thermal treatment of step d) does not include the heating or cooling time.

According to a specific embodiment, the thermal treatment of step d) is advantageously a thermal quenching performed at a temperature in the range from 450 to 600° C., advantageously from 400 to 550° C., for a duration in the range from 15 to 120 minutes.

According to a preferred embodiment, the method comprises the steps of:
a) preparing an iron borate from an iron compound and a boron compound, by thermal quenching under an inert atmosphere (argon or nitrogen) at a temperature in the range from 650 to 850° C. for a duration in the range from 5 to 30 minutes, advantageously from 5 to 20 minutes;
b) preparing a cobalt borate from a cobalt compound and a boron compound, by thermal quenching under an oxidizing atmosphere (advantageously, air) at a temperature in the range from 700 to 850° C. for a duration in the range from 5 to 30 minutes, advantageously from 5 to 20 minutes;
c) preparing and milling a mixture containing the iron borate, the cobalt borate, a precursor of lithium, and boric acid;
d) thermally quenching the mixture under an inert atmosphere (argon or nitrogen), at a temperature in the range from 400 to 550° C. for a duration in the range from 15 to 120 minutes;
e) obtaining a material of formula LiFe₁₋ₓCoₓBO₃, with 0<x<1.

The final product obtained at step e) is a material of formula LiFe₁₋ₓCoₓBO₃ where x is greater than 0 and smaller than 1. In other words, the material necessarily comprises iron or cobalt.

It is a monoclinic crystal material. It generally appears in the form of particle agglomerates.

The average diameter of the agglomerates obtained after the thermal treatment of step d) is advantageously in the range from 0.5 to 10 micrometers, more advantageously from 0.5 to 5 micrometers. It depends, in particular, on the nature of the thermal treatment. It is advantageously in the range from 1 to 5 micrometers in the case of thermal quenching, while it is advantageously in the range from 4 to 10 micrometers when the thermal treatment does not correspond to a quenching step.

The average diameter of the primary particles forming the agglomerates and obtained after the thermal treatment of step d) is advantageously in the range from 0.1 to 1 micrometer, more advantageously from 0.1 to 0.5 micrometer. It depends, in particular, on the nature of the thermal treatment. It is advantageously in the range from 0.1 to 0.4 micrometer in the case of thermal quenching, while it is advantageously in the range from 0.5 to 1 micrometer when the thermal treatment does not correspond to a quenching step.

The present invention also relates to the lithium-ion battery comprising a cathode where the electronically-active material is the material of formula LiFe₁₋ₓCoₓBO₃, with 0<x<1.

It will be within the abilities of those skilled in the art to implement conventional techniques to prepare this battery, particularly by preparing a cathode by deposition of the LiFe₁₋ₓCoₓBO₃ material on a current collector.

As an example, the deposition may be that of an ink containing the active electrode material previously milled in the presence of an electron conductor Typically, the electron conductors used are vapor grown carbon fibers (VGCF), or more advantageously carbon black such as Ketjenblack®.

The invention and the resulting advantages will better appear from the following non-limiting drawings and examples, provided as an illustration of the invention.

### DESCRIPTION OF THE DRAWINGS

FIG. 1 corresponds to the diffractograms of the LiFe₁₋ₓCoₓBO₃ compounds when x=0; 0.5; and 1.

FIG. 2 corresponds to an enlarged view of the diffractograms of the LiFe₁₋ₓCoₓBO₃ compounds when x=0; 0.5; and 1.

FIG. 3 is an image obtained by scanning electron microscopy (SEM) of the LiFe_{0,5}Co_{0,5}BO₃ compound according to a specific embodiment of the invention.

FIG. 4 corresponds to the C/20 galvanostatic cycling for the LiFe₁₋ₓCoₓBO₃ compounds (x=0.5 and 1).

FIG. 5 corresponds to the cyclic voltammogram at 0.05 mV/s for the LiFe_{0,5}Co_{0,5}BO₃ compound.

### EMBODIMENTS OF THE INVENTION

Compounds of formula LiFe₁₋ₓCoₓBO₃ (x=0; 0.5; and 1) have been prepared according to an embodiment of the method forming of object of the present invention.

1/ Preparation of LiFe₁₋ₓCoₓBO₃ (x=0; 0.5; and 1)

The LiFe₁₋ₓCoₓBO₃ compound has been prepared according to the steps of:
a) preparing an iron borate from an iron compound and a boron compound;
b) preparing a cobalt borate from a cobalt compound and a boron compound;
c) preparing and milling a mixture containing the iron borate, the cobalt borate, a precursor of lithium, and boric acid;
d) thermally treating the mixture under an inert atmosphere;
e) obtaining the material of formula LiFe₁₋ₓCoₓBO₃, with 0≦x≦1.

In this method, the iron borate, Fe₂B₂O₅, and the cobalt borate, Co₃B₂O₆, are synthe-sized separately.

Step a): Iron Borate Synthesis

The boron and iron compounds are dispersed in cyclohexane and mixed for five hours at 500 revolutions per minute in a 50-ml bowl containing 10 stainless steel balls by means of a planetary mill (Retsch). The cyclohexane is then evaporated in air.

This mixture is then thermally treated in an alumina crucible under an inert atmosphere (argon) at 800° C. for 30 minutes with a temperature ramp of 5° C. per minute in rising mode and of 10° C. per minute in falling mode.

Step b): Cobalt Borate Synthesis

The boron and cobalt compounds are mixed in the same way as for the iron borate.

The mixture is then thermally treated in an alumina crucible in air at 800° C. for six hours with a temperature ramp of 5° C. per minute in rising mode and of 10° C. per minute in falling mode.

Step c): Preparation and Milling of a Mixture of Fe, Co, Li Compounds

The iron and cobalt borates are then mixed with the lithium salt and the boric acid. For this purpose, the compounds, in powder form, are dispersed in cyclohexane and mixed for five hours at 500 revolutions per minute in a 50-ml bowl containing 10 stainless steel balls by means of a planetary mill (Retsch).

The cyclohexane is then evaporated in air.

Steps d) and e): Thermal Treatment and Obtaining of LiFe₁₋ₓCoₓBO₃

The mixture is then thermally treated in an alumina crucible under an inert atmosphere (argon) at 500° C. for 90 minutes with a temperature ramp of 5° C. per minute in rising mode and of 20° C. per minute in falling mode.

The compounds used and the respective quantities are mentioned in tables 1 and 2. The lithium and the boron are introduced in slight excess relative to the iron and/or to the cobalt.

TABLE 1
compounds implemented to prepare the iron and cobalt borates

| | | | B₂O₃ (g) |
|---|---|---|---|
| x | FeC₂O₄•2H₂O (g) | CoC₂O₄•2H₂O (g) | step a) − step b) |
| 0 | 3.38 | 0 | 0.66-0 |
| 0.5 | 3.38 | 7.32 | 0.66-1.39 |
| 1 | 0 | 7.32 | 0-1.39 |

TABLE 2
compounds used to prepare LiFe₁₋ₓCoₓBO₃ (x = 0; 0.5; and 1)

| x | Fe₂B₂O₅ (g) | Co₃B₂O₆ (g) | Li₂CO₃ (g) | boric acid (g) |
|---|---|---|---|---|
| 0 | 0.87 | 0 | 0.32 | 0 |
| 0.5 | 0.44 | 0.40 | 0.32 | 0.09 |
| 1 | 0 | 1.50 | 0.59 | 0.32 |

2/ Electrochemical Tests:

a) Preparation of the Positive Electrode

The active LiFe_{0,5}Co_{0,5}BO₃ material is mixed by 85 wt. % with carbon of large specific surface area (Ketjenblack JD600) (15 wt. %) for 4 hours at 500 revolutions per minute in a 50-ml bowl containing 10 stainless steel balls by means of a planetary mill (Retsch).

Then, the obtained product is mixed by 90 wt. % with polyvinylidene fluoride (10 wt. %) dissolved in N-methyl-2-pyrrolidone.

Finally, the mixture is spread on an aluminum foil (100-μm) and then dried at 60° C.

The electrode is then made of 76.5 wt. % of active material; 13.5 wt. % of carbon, and 10 wt. % of polyvinylidene fluoride (PVDF).

b) Mounting of the Accumulator

The formed electrode is introduced into a cell of “button cell” type at format 2032.

The negative electrode is made of metal lithium.

Two types of separators have been used:
a polypropylene film (Celgard® 2400), and
a polyolefin film (Viledon®).

The electrolyte used is made of ethylene carbonate, of propylene carbonate, of dimethyl carbonate, and of lithium hexafluorophosphate (LiPF₆) (Powerlyte's Electrolyte LP100).

c) Galvanostatic Cycling

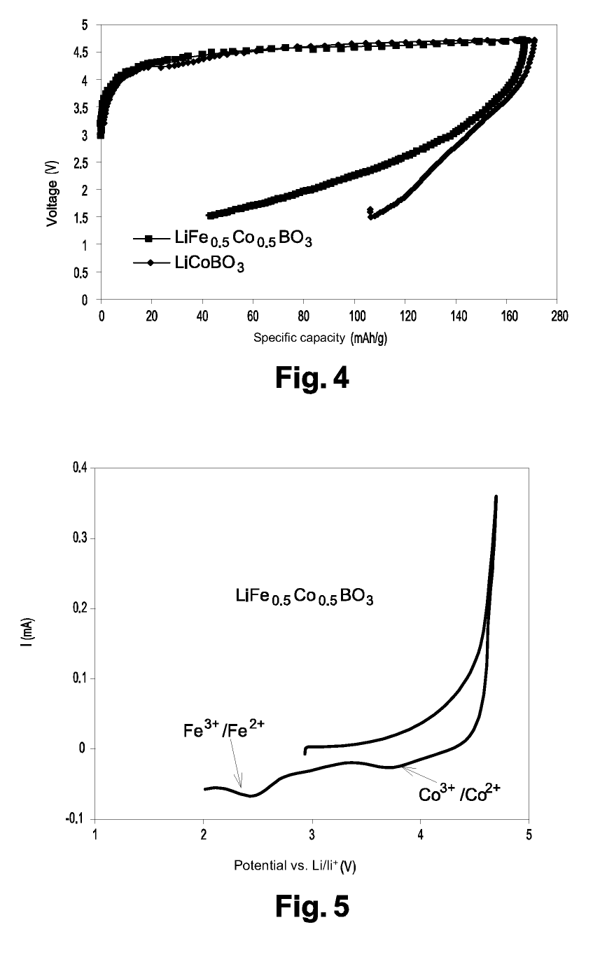

At room temperature, a current is imposed to the system to obtain a C/20 rate, that is, the extraction/insertion of a lithium ion within 20 hours. FIG. 4 enables to compare the first cycle of a C/20 galvanostatic cycling between 1.5 and 4.7 V for the LiFe_{0,5}Co_{0,5}BO₃ and LiCoBO₃ compounds.

Further, FIG. 4 shows that the reversible capacity (that is, the capacity obtained in discharge mode) obtained at the first cycle for the LiFe_{0,5}Co_{0,5}BO₃ compound is much greater than that obtained for LiCoBO₃: 125 mAh/g vs. 64 mAh/g.

FIG. 5 corresponds to the cyclic voltammogram at 0.05 mV/s for the LiFe_{0,5}Co_{0,5}BO₃ compound. This graph shows the redox potential of the Fe³⁺/Fe²⁺ and Co³⁺/Co²⁺ couples of the LiFe_{0,5}Co_{0,5}BO₃ compound.

3/ Characterization of the LiFe₁₋ₓCoₓBO₃ Compound:

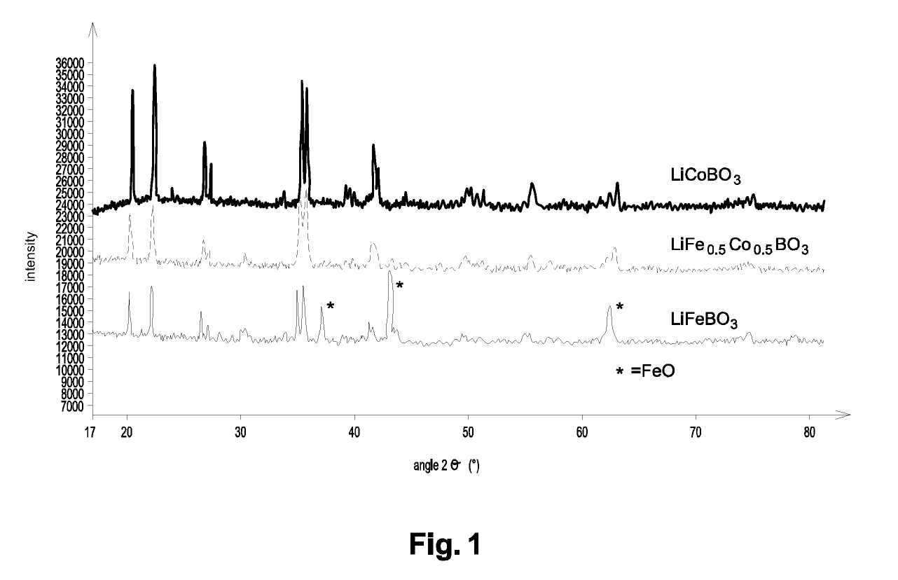

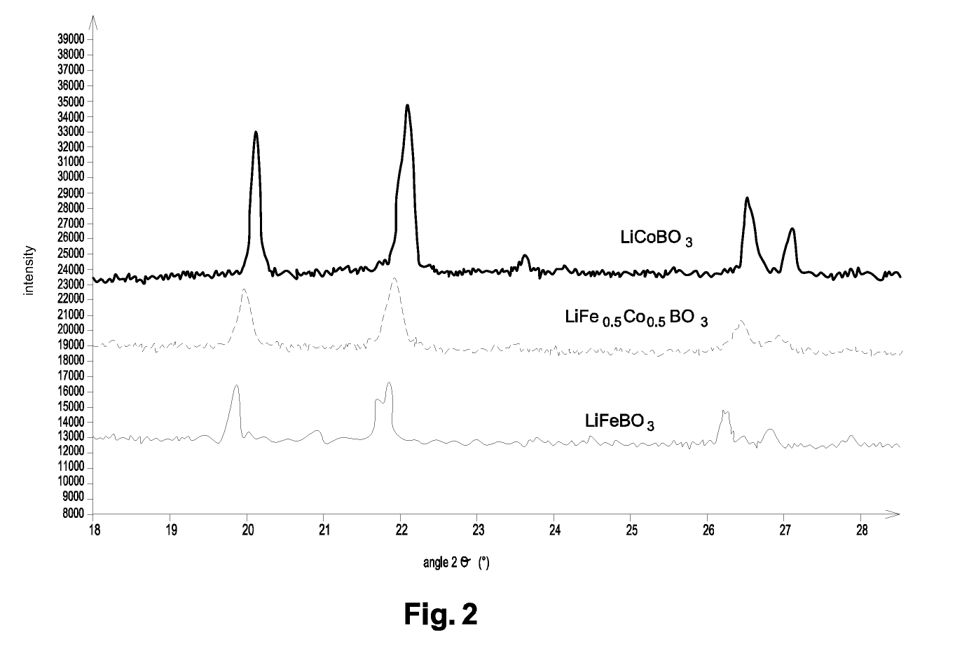

FIGS. 1 and 2 correspond to the diffractograms of the LiFe₁₋ₓCoₓBO₃ compounds when x=0; 0.5; and 1. They clearly show that the monoclinic structure is kept for LiFe_{0,5}Co_{0,5}BO₃.

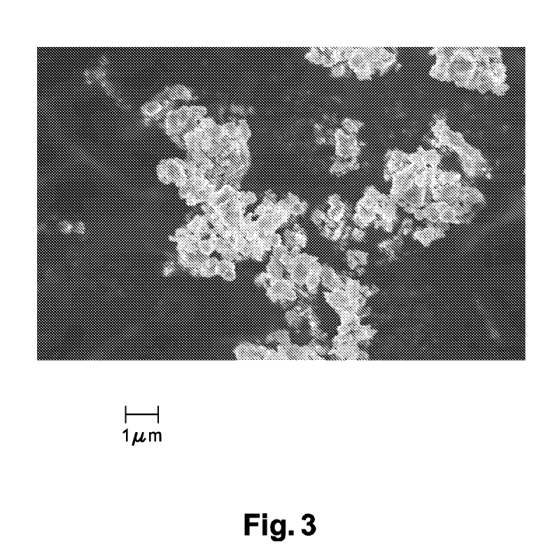

FIG. 3 corresponds to an image obtained by scanning electron microscopy (SEM) of the LiFe_{0,5}Co_{0,5}BO₃ compound according to the present invention.

1. An electrode material of formula LiFe₁₋ₓCoₓBO₃, wherein 0<x<1.

2. The electrode material of claim 1, wherein 0<x≦0.3.

3. A method of preparing an electrode material of formula LiFe₁₋ₓCoₓBO₃, with 0<x<1, comprising the steps of:
a) preparing an iron borate from an iron compound and a boron compound by:
a1) milling of a mixture of an iron compound and of a boron compound;
a2) thermal treatment of the mixture thus obtained, under an inert atmosphere, at a temperature in the range from 300 to 1,000° C.;
b) preparing a cobalt borate from a cobalt compound and a boron compound by:
b1) milling of a mixture of a cobalt compound and of a boron compound;
b2) thermal treatment of the mixture thus obtained, under an oxidizing atmosphere, at a temperature in the range from 300 to 1,000° C.;
c) preparing a mixture containing the iron borate, the cobalt borate, a precursor of lithium, and boric acid;
d) thermally treating the mixture under an inert atmosphere;
e) obtaining a material of formula LiFe₁₋ₓCoₓBO₃, with 0<x<1.

4. The method of claim 3, wherein the iron compound is selected from the group consisting of: iron oxalate; iron carbonate; and iron oxide (II).

5. The method of claim 3, wherein the cobalt compound is selected from the group consisting of: cobalt oxalate; cobalt carbonate; and cobalt oxide (II).

6. The method of claim 3, wherein the boron compound is boron oxide or boric acid.

7. The method of claim 3, wherein the lithium precursor is lithium carbonate or lithium hydroxide.

8. The method of claim 3, wherein the thermal treatment of step d) is carried out at a temperature in the range from 300 to 900° C., for a duration in the range from 30 to 1,200 minutes.

9. The method of claim 3, wherein it comprises the steps of:
a) preparing an iron borate from an iron compound and a boron compound, by thermal quenching under an inert atmosphere at a temperature in the range from 650 to 850° C. for a duration in the range from 5 to 30 minutes;
b) preparing a cobalt borate from a cobalt compound and a boron compound, by thermal quenching under an oxidizing atmosphere at a temperature in the range from 700 to 850° C. for a duration in the range from 5 to 30 minutes;
c) preparing and milling a mixture containing the iron borate, the cobalt borate, a precursor of lithium, and boric acid;
d) thermally quenching the mixture under an inert atmosphere, at a temperature in the range from 400 to 550° C. for a duration in the range from 15 to 120 minutes;
e) obtaining a material of formula LiFe₁₋ₓCoₓBO₃, with 0<x<1.

10. A lithium-ion battery comprising a cathode; having an electronically-active material that is the material of claim 1.

11. A lithium-ion battery comprising a cathode having an electronically-active material that is the material of claim 2.

12. The method of claim 3, wherein the thermal treatment of step d) is carried out at a temperature in the range from 400 to 700° C., for a duration in the range from 30 to 1,200 minutes.

13. The method of claim 4, wherein the cobalt compound is selected from the group consisting of: cobalt oxalate; cobalt carbonate; and cobalt oxide (II).

14. The method of claim 4, wherein the boron compound is boron oxide or boric acid.

15. The method of claim 13, wherein the boron compound is boron oxide or boric acid.

16. The method of claim 4, wherein the lithium precursor is lithium carbonate or lithium hydroxide.

17. The method of claim 13, wherein the lithium precursor is lithium carbonate or lithium hydroxide.

18. The method of claim 14, wherein the lithium precursor is lithium carbonate or lithium hydroxide.

19. The method of claim 15, wherein the lithium precursor is lithium carbonate or lithium hydroxide.

20. The method of claim 3, wherein the boron compound is boron oxide or boric acid and the lithium precursor is lithium carbonate or lithium hydroxide.
